(19) United States
(12) Patent Application Publication
(10) Pub. No.: US 2013/0169828 A1
(43) Pub. Date: Jul. 4, 2013

(54) METHOD AND APPARATUS FOR TAGGING LOCATION INFORMATION

(71) Applicant: Samsung Electronics Co., Ltd., Suwon-si (KR)

(72) Inventors: Jong-Dong LEE, Seoul (KR); Ju-Bong LEE, Anyang-si (KR)

(73) Assignee: SAMSUNG ELECTRONICS CO. LTD., Suwon-si (KR)

(21) Appl. No.: 13/666,237

(22) Filed: Nov. 1, 2012

(30) Foreign Application Priority Data
Jan. 4, 2012 (KR) 10-2012-0000973

(51) Int. Cl. H04N 5/225

(52) U.S. Cl. 348/207.1; 348/E05.024

(57) ABSTRACT

A method for using location information is provided. In the method, location information of the mobile terminal is stored every N-basis interval in a motion picture stream. Time information is obtained from the motion picture stream every N-basis interval. Information of a current area of the mobile terminal is obtained every N-basis interval. When a previous area and a current area are different from each other, information of the current area is stored.

### PRIORITY

This application claims the benefit under 35 U.S.C. §119(a) of a Korean patent application filed in the Korean Intellectual Property Office on Jan. 4, 2012 and assigned Serial No. 10-2012-0000973, the entire disclosure of which is hereby incorporated by reference.

### BACKGROUND OF THE INVENTION

1. Field of the Invention

The present invention relates to a method and an apparatus for tagging location information in an electronic device. More specifically, the present invention relates to a method and an apparatus for efficiently tagging and managing geographical location information while recording motion pictures in the electronic device.

2. Description of the Related Art

While recording motion pictures, a method for storing location information may involve obtaining location information data from a Global Positioning System (GPS) and a recording motion picture stream from an image input unit, simultaneously, and then synchronizing information every frame using an absolute time of a synchronization signal generator as an index.

Alternatively, the method may involve obtaining and storing location information and time information for each frame from a GPS simultaneously with starting of motion picture recording, and collectively synchronizing the location information and the time information when the motion picture recording ends.

When location information and time information are recorded in each frame, in most cases information is recorded twice: on the former frame and the latter frame of one reference frame.

This doubly recorded value is unnecessary information. When the unnecessary information increases, additional processing time is needed when structuring or displaying content.

Where a plurality of motion picture content recorded for one hour or more while passing by at least five areas exist, when the content should be classified on an area basis, it may be necessary to compare and search for much location information using a Location Based Service (LBS) or a map service in order to perform the classification, so that additional time is required for configuring a list. In addition, to display these data to a user in a clearly organized manner, a separate data post processing is necessary. Since these technologies are designed with consideration of only tracking in motion pictures, processing for duplicated information is not efficient.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for tagging location information.

Another aspect of the present invention is to provide a method and an apparatus for efficiently tagging necessary location information when recording motion pictures and displaying location information desired by a user.

Still another aspect of the present invention is to provide a method and an apparatus for understanding a geographical name or a velocity and a characteristic of motion pictures when recording motion pictures to tag substantially valid location information.

Yet another aspect of the present invention is to provide a method and an apparatus for processing data structuring for motion picture management and list management fast and accurately using geographical information in a mobile terminal.

In accordance with an aspect of the present invention, a method for using location information in a mobile terminal is provided. The method includes storing location information of the mobile terminal every N-basis interval in a motion picture stream, obtaining time information from the motion picture stream every N-basis interval, obtaining information of a current area of the mobile terminal every N-basis interval, and when a previous area and a current area are different from each other, storing the information of the current area.

In accordance with another aspect of the present invention, an apparatus of a mobile terminal that uses location information is provided. The apparatus includes a camera for recording motion pictures; a location information receiver for obtaining location information; a modem for receiving information of a current area, a controller for storing location information of the mobile terminal in a motion picture stream every N-basis interval via the camera, obtaining time information from the motion picture stream every N-basis interval, obtaining information of a current area of the mobile terminal every N-basis interval, and when a previous area and a current area are different from each other, storing the information of the current area, and a storage for storing the motion picture stream, the time information, and the information of the current area.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1 is a block diagram illustrating a Group of Pictures (GOP) manager performing location information tagging on a GOP basis in a mobile terminal according to an exemplary embodiment of the present invention;

FIG. 2 is a block diagram illustrating a location information manager in a mobile terminal according to an exemplary embodiment of the present invention;

FIG. 3 is a flowchart illustrating a GOP tagging process according to an exemplary embodiment of the present invention;

FIG. 4 is a flowchart illustrating a location information managing process according to an exemplary embodiment of the present invention;

FIG. 5 is a block diagram illustrating a mobile terminal according to an exemplary embodiment of the present invention; and

FIG. 6 is a view illustrating an example of information stored in a database according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present invention relates to a method and an apparatus for efficiently tagging and managing geographical location information while recording motion pictures, allowing a user to easily find a desired motion picture depending on location information, and displaying the found motion picture on a map in a mobile terminal including a location information receiver and a camera.

Exemplary embodiments of the present invention provide a method and an apparatus for tagging location information. A method according to an exemplary embodiment of the present invention includes obtaining field information of a motion picture stream when recording motion pictures in a mobile terminal to record location information in the motion picture stream, and controlling a tagging period so that duplicated location information tagging does not occur using the velocity or geographical information of the mobile terminal.

An apparatus according to an exemplary embodiment of the present invention uses a method of tagging location information recorded while encoding when recording a motion picture on a Group of Picture (GOP) basis, unlike a method of receiving time information from a location information receiver such as a GPS receiver simultaneously with location information to store and manage the information in every frame of a motion picture frame. Exemplary embodiments of the present invention perform a process of allowing a motion picture stream to coincide with location information every GOP when recording a motion picture in a mobile terminal.

Exemplary embodiments of the present invention perform a process for calculating a velocity of the mobile terminal to set a location information tagging period determining whether to tag location information every N-GOP depending on the velocity in order to avoid location information duplication, and inserting the location information tagged on a GOP basis into a motion picture stream depending on the location information tagging period.

In addition, exemplary embodiments of the present invention determine whether a current location has changed on a GOP basis with reference to a table that has recorded a location that depends on a geographical name basis or a geographical size by setting in a storage of a mobile terminal, and records the location information in a database only if the current location has changed, thereby avoiding duplicated location information recording.

During this process, exemplary embodiments of the present invention use a location information value obtained from a location information receiver and a geographical information service system of the mobile terminal or an external geographical information service in order to determine whether duplicated location information exists.

In the above-described process, a process for allowing a motion picture stream to coincide with current location information of the mobile terminal, and tagging the location information while recording motion pictures is described below.

Exemplary embodiments of the present invention tag location information on one field of an MPEG stream on a GOP basis, which is a group basis, not a frame basis (Intracoded-frame/Predictive-frame/Bidirectional-coded-frame).

The location information recoding on a GOP basis has various improvements compared to locating information recording on a frame basis. When location information is matched and tagged every frame, density of location information increases, so that duplicated information increases more than necessary and after motion picture recording is completed, additional processing is required for data structuring.

To classify, on a region basis designated by a user, motion pictures on which location information has been recorded on a frame basis to list the same in the form of a sequence, or to display the same via a map service application, the user should search for and classify a large amount of location information recorded for each frame in proportion to a recording time of the motion picture using post processing.

When the density of location information is high, a close portion on a map may be magnified and tracked simultaneously with playing of motion pictures, but tracking guaranteeing accuracy of a predetermined level or more may be possible with only a GOP interval. In addition, a sequence of a frame on an MPEG stream may not coincide with a reproduction sequence of motion pictures. In a structure of an Intracoded-frame (I-frame), a Predictive-frame (P-frame), and a Bidirectional-coded frame (B-frame) of an MPEG video, to decode the B-frame, information of latter I-frame and P-frame is required in addition to the previous I-frame and P-frame. A difference between a reproduction sequence of motion pictures and a sequence of a stream where an I-frame, a P-frame, and a B-frame are located denotes that the sequence of the stream is different from a time of the motion pictures actually reproduced. This aspect means that an I-frame and a P-frame after the motion picture reproduction sequence should be decoded in advance in time for a Decoding Time Stamp (DTS). Exemplary embodiments of the present invention store a decoding-completed motion picture stream in a buffer, and output the motion picture stream in time for a Presentation Time Stamp (PTS).

One GOP includes one intra-frame and several inter-frames. Location information may be recorded using an intra-frame where only one frame exists in a GOP as a reference, but when Multi-view Video Coding (MVC) or Scalable Video Coding (SVC) is considered, it is preferable in an aspect of load reduction to tag and analyze location information on a GOP basis.

An operation method for tagging and recording on a GOP basis is described below. For tagging and recording on a GOP basis, location information is recorded on an MPEG user data region at the same time as location information is stored in a database of the Internet or an independent storage or a file (database) of a mobile terminal separately, and a PTS time of an image stream included in a Packetized Elementary Stream (PES) is stored.

This MPEG user data is divided into a sequence level, a GOP level, and a picture level of an MPEG stream, which are divided by a fragmentation rule of a PES. The fragmentation rule of the PES is divided into a sequence/GOP/picture level. Exemplary embodiments of the present invention records location information on MPEG user data region fragmentized using the GOP level.

Location information configured on a GOP basis tagged on an MPEG user data region may be used for the purpose of tracking a location on a map while a user reproduces motion pictures or obtaining neighborhood information while tracking a location. In addition, even when displaying a map with consideration of existence of location information of a plurality of areas inside a single motion picture, an accurate location may be displayed on the motion picture stream.

The location information is stored not only in the MPEG user data region but also in a database of the mobile terminal, a database of the Internet, or a separate independent storage indexed for each location information together with PTS information, simultaneously. Before obtaining location information and a PTS of a motion picture stream and storing the same in a storage unit while recording motion pictures, a separate condition comparison process is performed, so that unnecessary data is not tagged and recorded in the storage. The reason is for displaying a list regarding a place name or regional location information to a user fast on the mobile terminal without deterioration in a speed by the separate post processing after the motion picture recording is completed.

The condition comparison process is divided into two steps.

The first step includes a process for controlling an interval for obtaining location information. This is a process for controlling the number N of GOP intervals to determine whether to tag and record location information at which number of GOP intervals depending on a user's location change velocity.

The second step includes a process for comparing a condition value on a location or region basis based on a geographical size set by a user to control duplicated location information recording. The second process is performed when location information is recorded in a database, and PTS information is recorded together.

When the first process is performed, both motion picture recording during fast motion and motion picture recording during slow motion are present. In the motion picture recording during slow motion, recording location information every GOP has a high possibility of tagging duplicated location information. Accordingly, velocity is determined using location information and time information, an interval of a GOP is controlled, and tagging information of a motion picture stream (MPEG user data region) stored in a storage is performed.

For example, when a table determining a GOP interval N depending on a velocity is configured, a table of 0 km/h˜5 km/h=30GOP, 5 km/h˜10 km/h=20GOP, 10 km/h˜15 km/h=10GOP, 15 km/h˜20 km/h=5GOP, 20 km/h˜30 km/h=3GOP, 30 km/h˜1GOP may be configured. Depending on a table value according to a velocity, a system adaptively determines a GOP interval to tag location information.

In the case where a mobile terminal moves at a velocity of 24 km/h, location information and PTS information are tagged and recorded every 3 GOP. This table value may be classified based on a movement means or kind, or may be set by a user.

When the second process is performed, in case of comparing a geographical size, an area on a block basis set by a user in the form of 3-sided, four-sided, or many-sided shape is used.

During motion picture recording, the mobile terminal arranges blocks constantly depending on a set value selected by a user using a start point or a point of setting a geographical size as a reference, and compares geographical information in the arranged block with geographical information recorded on a previous GOP. When the mobile terminal is located in the same block, current geographical information is regarded as duplicated location information, so that the geographical information is not tagged in the storage.

In case of comparing an area basis, a name of an area is determined using one of building, street-basis or city, state-basis or town, township-basis as a reference using a Location Based Service (LBS) or a map service on the Internet, and whether a location of a current area and a location of a previous area have been duplicated are compared and determined.

For example, in the case where an area basis is set by a user and a location information value obtained according to a set GOP interval is transferred to an LBS processor or a map service, the mobile terminal obtains a name of an area on the area basis set by the user, regards the name as the duplicated area information when the obtained name is the same as a name of an area previously stored to avoid tagging and recording, and tags the area information in a separate storage of the mobile terminal or a database on the Internet when the obtained name is different from the name of the area previously stored.

A motion picture stream stored in the storage of the mobile terminal may be sorted for each area basis using an LBS or a map service system, and displayed in the form of a sorted list.

Alternatively, when an indicator is set on a specific location on a map, a still image of a place where the indicator is located may be displayed in the form of a thumbnail, and a motion picture stream may be displayed in a size of the thumbnail from a PTS time position of the motion picture stream for a predetermined time together with time information. A trace corresponding to a geographical location of a motion picture recorded while the mobile terminal moves may be displayed and the motion picture may be displayed together with the trace.

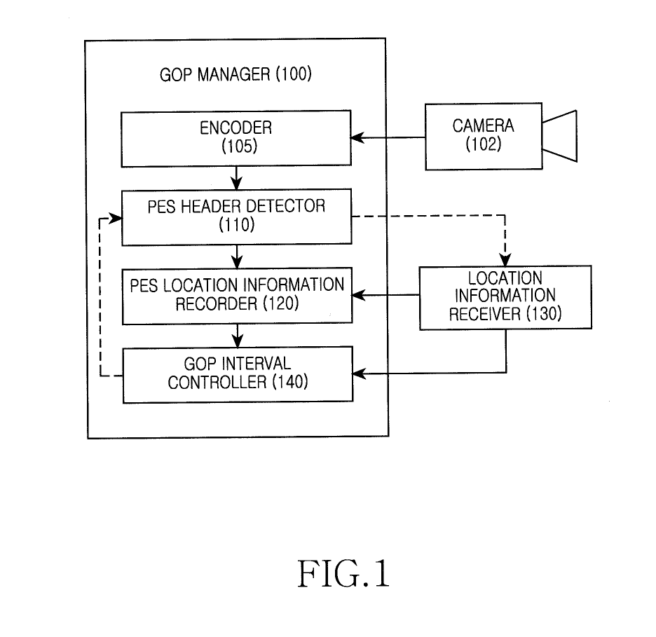

FIG. 1 is a block diagram illustrating a GOP manager performing location information tagging on a GOP basis in a mobile terminal according to an exemplary embodiment of the present invention.

Referring to FIG. 1, a GOP manager 100 includes an encoder 105, a PES header detector 110, a PES location information recorder 120, a location information receiver 130, and a GOP interval controller 140.

The encoder 105 encodes an image input from a camera 102 such that the image input is suitable for a relevant codec, and outputs the same.

When detecting a PES header of an N-th GOP from output data of the encoder 105, the PES header detector 110 outputs a control signal to the location information receiver 130. The PES header detector 110 outputs data output by the encoder 105.

In case of receiving a control signal of the PES header detector 110, the location information receiver 130 outputs current location information.

The PES location information recorder 120 that has received location information output by the location information receiver 130 records location information in data of the encoder 105 output by the PES header detector 110.

The GOP interval controller 140 calculates a current velocity of the mobile terminal using provided current location information and previous location information, and determines a GOP interval N according to the calculated velocity to provide the same to the PES header detector 110. A method for determining a GOP interval uses the above-described table referring method.

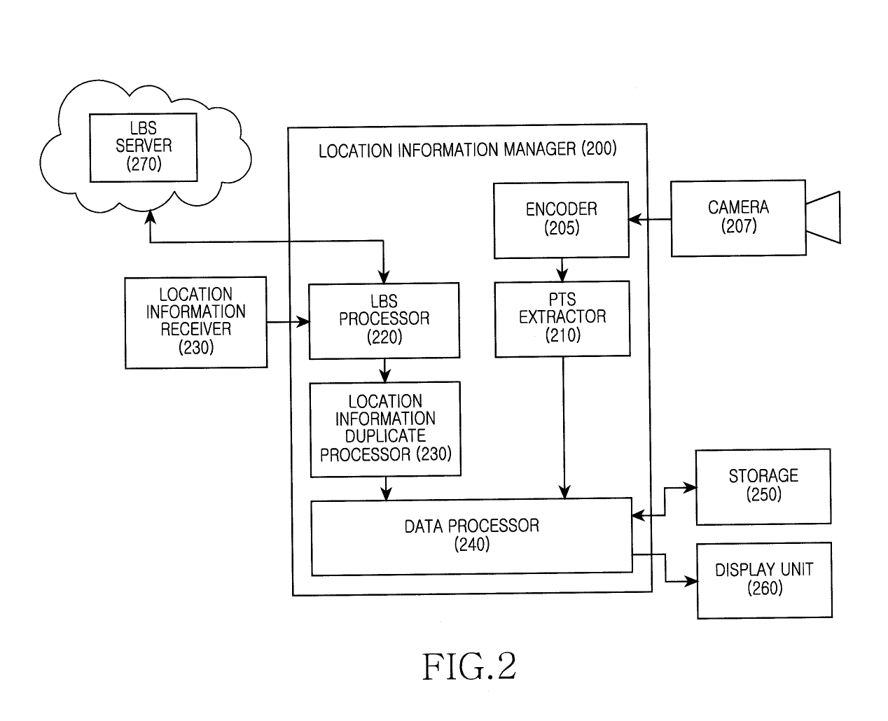

FIG. 2 is a block diagram illustrating a location information manager in a mobile terminal according to an exemplary embodiment of the present invention.

Referring to FIG. 2, the location information manager 200 includes an encoder 205, a PTS extractor 210, an LBS processor 220, a location information duplicate processor 230, and a data processor 240. The encoder 205 is the same as the encoder 105 of FIG. 1. In addition, a location information receiver 230 and a camera 207 are the same as the location information receiver 130 and the camera 102 of FIG. 1.

The encoder 205 encodes an image input from the camera 207 such that the image input is suitable for a relevant codec.

The PTS extractor 210 outputs a PTS of an image stream included in a PES from output data of the encoder 205. The PTS extractor 210 may output a PTS every N-th GOP.

The LBS processor 220 communicates with the LBS server 270 based on location information provided by the location information receiver 230 every N-th GOP to provide a location-based service to the mobile terminal For example, the LBS processor 220 may provide a name of an area where the mobile terminal is currently located to the location information duplicate processor 230.

When the name of the area where the mobile terminal is currently located provided by the LBS processor 220 is the same as the previous name, the location information duplicate processor 230 does not request the data processor 240 to store the name. Only when the name of the area where the mobile terminal is currently located is not the same as the previous name does the location information duplicate processor 230 request the data processor 240 to store the name. This storing request is performed every N GOP interval and stored in a database.

The data processor 240 records or does not record a name of a current area according to a request of the location information duplicate processor 230. In addition, the data processor 240 stores a PTS provided by the PTS extractor 210 in a database every N GOP interval. The database is included in the storage 250.

The display unit 260 displays an output of the data processor 240. When an indicator is set on a map, a still image of a place where a relevant indicator is located may be displayed in the form of a thumbnail, and a motion picture may be displayed in the thumbnail size from a location of a PTS of the motion picture stream for a predetermined time together with time information.

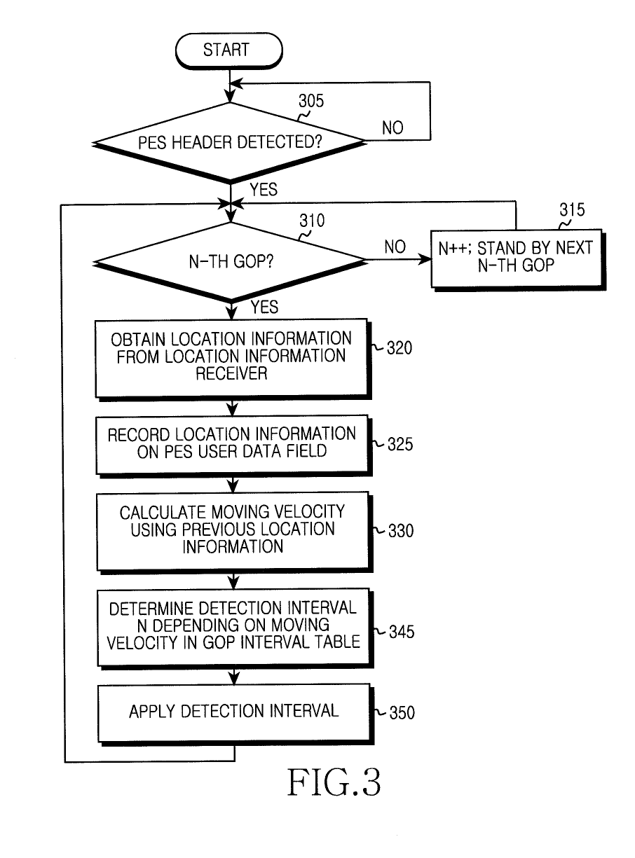

FIG. 3 is a flowchart illustrating a GOP tagging process according to an exemplary embodiment of the present invention.

Referring to FIG. 3, the GOP manager monitors a PES header from an encoded motion picture stream in step 305. When an N-th GOP is found in step 310, the GOP manager obtains location information from a location information receiver in step 320.

The GOP manager records the obtained location information in a PES user data field (MPEG user data region) in step 325. In addition, the GOP manager calculates a current velocity of a mobile terminal using previous location information in step 330.

The GOP manager determines a detection interval (GOP interval) N depending on a velocity determined in a GOP interval table in step 345. The GOP manager applies the detection interval (GOP interval) N in step 350.

When an N-th GOP is not found in step 310, the GOP manager increases an N value by 1 and stands by until a next N-th GOP is found in step 315.

The method described above in relation with FIG. 3 under of the present invention may be provided as one or more instructions in one or more software modules stored in the respective apparatus.

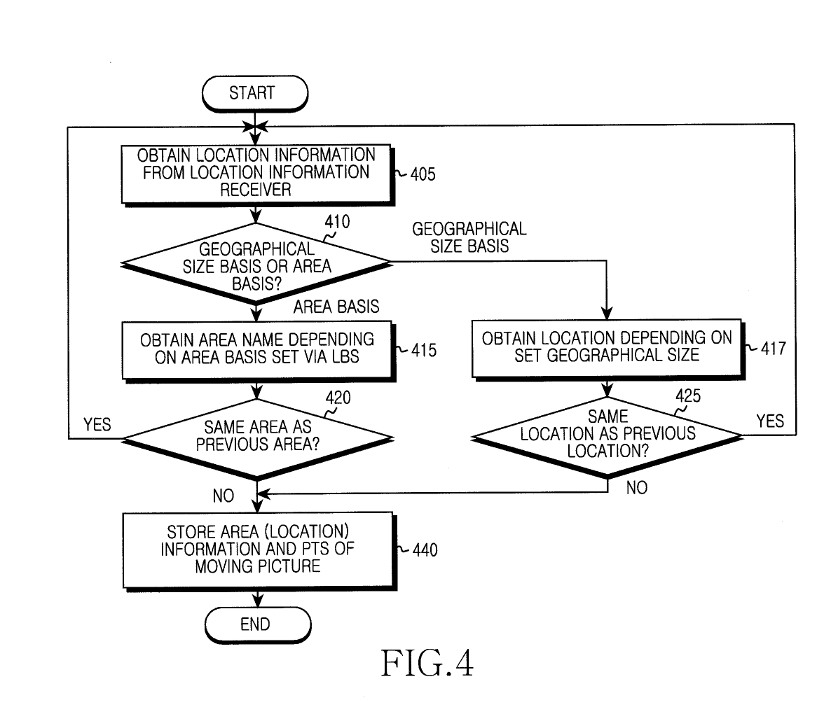

FIG. 4 is a flowchart illustrating a location information managing process according to an exemplary embodiment of the present invention.

Referring to FIG. 4, a location information manager obtains location information from a location information receiver in an N-th GOP in step 405.

When a current set reference is an area basis in step 410, the location information manager obtains an area name corresponding to a current location of a mobile terminal from an LBS server on the Internet in step 415.

When the current area is not the same as a previous area in step 420, the location information manager stores the current area information and PTS information of a motion picture in a database in step 440.

When the current set reference is a geographical size basis in step 410, the location information manager obtains a location corresponding to a set geographical size in step 417. When the current location is not the same as a previous location in step 425, the location information manager stores the current location information and PTS information of a motion picture in a database in step 440.

The method described above in relation with FIG. 4 under of the present invention may be provided as one or more instructions in one or more software modules stored in the respective apparatus.

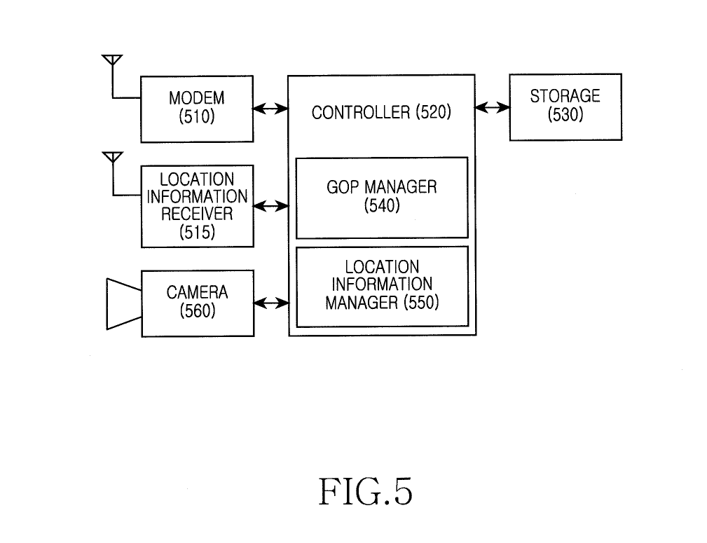

FIG. 5 is a block diagram illustrating a mobile terminal according to an exemplary embodiment of the present invention.

Referring to FIG. 5, the mobile terminal includes a modem 510, a location information receiver 515, a controller 520, a storage 530, and a camera 560.

The modem 510 serves as a module for communicating with other devices, and includes a Radio Frequency (RF) processor and a baseband processor. The RF processor converts a signal received via an antenna into a baseband signal to provide the same to the baseband processor, and converts a baseband signal from the baseband processor into an RF signal so that it can be actually transmitted on an air to transmit the same via the antenna.

The controller 520 controls an overall operation of the mobile terminal. According to an exemplary embodiment of the present invention, the controller 520 includes or controls a GOP manager 540 and a location information manager 550.

The storage 530 stores a program for controlling an overall operation of the mobile terminal and temporary data generated during execution of a program. The storage 530 includes a database that stores location (area) information and a PTS. In addition, the storage 530 stores a GOP interval table.

The GOP manager 540 detects a PES header from a motion picture stream encoded via the camera 560. When finding an N-th GOP, the GOP manager 540 obtains location information from the location information receiver 515.

The GOP manager 540 records the obtained location information on a PES user data field. The GOP manager 540 calculates a current velocity of the mobile terminal using previous location information. The GOP manager 540 determines a detection interval (GOP interval) N depending on a velocity determined in a GOP interval table and applies the detection interval (GOP interval) N. When an N-th GOP is not found, the GOP manager 540 increases an N value by 1 and stands by until a next N-th GOP is found.

The location information manager 550 obtains location information from the location information receiver 550. When a current set reference is an area basis, the location information manager 550 obtains an area name corresponding to a current location of the mobile terminal from an LBS server on the Internet.

When the current area is not the same as a previous area, the location information manager 550 stores the current area information and PTS information of a motion picture in a database of the storage 530.

When the current set reference is a geographical size basis, the location information manager 550 obtains a location corresponding to a set geographical size. When the current location is not the same as a previous location, the location information manager 550 stores the current location information and PTS information of a motion picture in a database of the storage 530.

The mobile terminal may be an electronic device such as, for example, a laptop, a smart phone, a net book, a mobile internet device, an ultra mobile PC, a tablet personal computer, a mobile telecommunication terminal, PDA having a camera and the like herein, just to name some of the possibilities.

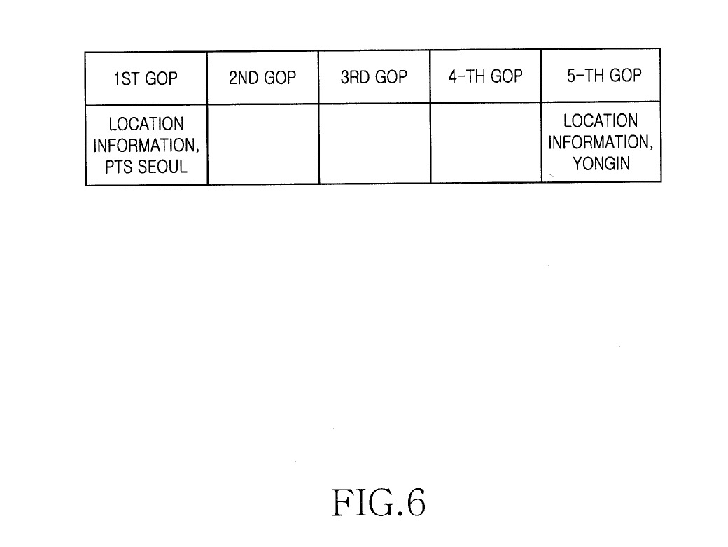

FIG. 6 is a view illustrating an example of information stored in a database according to an exemplary embodiment of the present invention.

Referring to FIG. 6, location information, PTS, and area information stored in a database are illustrated on the assumption that N=4. In case of N=4, location information, PTS, and area information are stored in the 1st, 5-th, and 9-th GOP. A 5-th GOP illustrates a case where an area has changed from Seoul to Yongin.

Exemplary embodiments of the present invention have an advantage of tagging location information with one or more GOP intervals to reduce a load and complexity for materialization compared to tagging for each frame. In addition, location information tagged to a separate storage minimizes duplicated location information, so that important information may be displayed to a user at fast speed without a separate processing when information is listed for each area or location in a mobile terminal or on the web.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

In addition, exemplary embodiments of the present invention have an advantage of having efficiency in a resource saving effect and data post processing compared to recording location information every frame under an MVC or an SVC environment that considers a 3D codec, etc.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for using location information in a mobile terminal, the method comprising:
storing location information of the mobile terminal every N-basis interval in a motion picture stream;
obtaining time information from the motion picture stream every N-basis interval;
obtaining information of a current area of the mobile terminal every N-basis interval; and
when a previous area and a current area are different from each other, storing the information of the current area.

2. The method of claim 1, further comprising, when the previous area is the same as the current area, not storing the information of the current area.

3. The method of claim 1, further comprising displaying the motion picture stream on a map every N-basis interval together with the time information depending on the location information.

4. The method of claim 1, further comprising determining the N-basis interval.

5. The method of claim 1, wherein the N-basis interval is determined based on a velocity of the mobile terminal.

6. The method of claim 1, wherein a discriminate basis of the area comprises an administrative district.

7. The method of claim 1, wherein a discriminate basis of the area comprises an area size.

8. The method of claim 1, wherein the time information comprises a Presentation Time Stamp (PTS).

9. The method of claim 1, wherein the N-basis interval comprises N Group of Picture (GOP) basis intervals.

10. The method of claim 1, wherein, the storing of the location information comprises inserting the information of the current area into a user data field of the motion picture stream.

11. An apparatus of a mobile terminal that uses location information, the apparatus comprising:
a camera for recording motion pictures;
a location information receiver for obtaining location information;
a modem for receiving information of a current area;
a controller for storing location information of the mobile terminal in a motion picture stream every N-basis interval via the camera, for obtaining time information from the motion picture stream every N-basis interval, for obtaining information of a current area of the mobile terminal every N-basis interval, and when a previous area and a current area are different from each other, for storing the information of the current area; and
a storage for storing the motion picture stream, the time information, and the information of the current area.

12. The apparatus of claim 11, wherein, when the previous area is the same as the current area, the controller does not store the information of the current area.

13. The apparatus of claim 11, further comprising a display unit for displaying the motion picture stream on a map every N-basis interval together with the time information depending on the location information under control of the controller.

14. The apparatus of claim 11, wherein the controller determines the N-basis interval.

15. The apparatus of claim 11, wherein the N-basis interval is determined based on a velocity of the mobile terminal.

16. The apparatus of claim 11, wherein a discriminate basis of the area comprises an administrative district.

17. The apparatus of claim 11, wherein a discriminate basis of the area comprises an area size.

18. The apparatus of claim 11, wherein the time information comprises a Presentation Time Stamp (PTS).

19. The apparatus of claim 11, wherein the N-basis interval comprises N GOP basis intervals.

20. The apparatus of claim 11, wherein the controller inserts the information of the current area into a user data field of the motion picture stream.
